(19) United States
(12) Patent Application Publication
(10) Pub. No.: US 2026/0179811 A1
(43) Pub. Date: Jun. 25, 2026

(54) RESISTOR AND METHOD FOR MANUFACTURING THE RESISTOR

(71) Applicant: Panasonic Intellectual Property Management Co., Ltd., Osaka (JP)

(72) Inventors: Motoki SHIOMI, Fukui (JP); Daisuke SUETSUGU, Osaka (JP); Nobutoshi TAKAGI, Hyogo (JP); Norimichi NOGUCHI, Osaka (JP); Tatsuya URAKAWA, Fukui (JP)

(21) Appl. No.: 19/125,640

(22) PCT Filed: Nov. 14, 2023
(86) PCT No.: PCT/JP2023/040853

§ 371 Date: Apr. 29, 2025

(30) Foreign Application Priority Data
Nov. 16, 2022 (JP) 2022-183514

(51) Int. Cl. H01C 7/00; H01C 1/14; H01C 17/12

(52) U.S. Cl. CPC H01C 7/006; H01C 1/14; H01C 17/12

(57) ABSTRACT

A resistor according to the present disclosure includes an insulating substrate, a resistor body, an electrode, and an oxynitride film. The resistor body contains Cr, Si, and N and is provided on the insulating substrate. The electrode contains at least one of Cu or Ag and is provided on the resistor body. The oxynitride film is provided on the resistor body. The electrode and the oxynitride film are arranged side by side in a second direction perpendicular to a first direction. The first direction defines a thickness direction with respect to the insulating substrate. The oxynitride film is in contact with an end portion of the electrode in the second direction.

### TECHNICAL FIELD

The present disclosure generally relates to a resistor and a method for manufacturing the resistor. More particularly, the present disclosure relates to a resistor including an insulating substrate and a resistor body provided on the insulating substrate, and a method for manufacturing such a resistor.

### BACKGROUND ART

Patent Literature 1 discloses a chip resistor (resistor) including an insulating substrate, a resistor body, and a pair of upper surface electrodes (electrodes). The resistor body is provided on the insulating substrate. The pair of upper surface electrodes are provided to partially cover the upper surface of the resistor body at both longitudinal end portions of the resistor body.

In the chip resistor of Patent Literature 1, a resistor body is formed on the insulating substrate first, a pair of upper surface electrodes are formed on the resistor body, and then a heat treatment is conducted. Thus, in some cases, an oxide film may be formed on at least one of the pair of upper surface electrodes. As a result, sometimes it is difficult to adjust the resistance value of the resistor body (i.e., to make trimming) by bringing a probe into contact with each of the pair of upper surface electrodes.

### CITATION LIST

### Patent Literature

Patent Literature 1: JP 2020-170843 A

### SUMMARY OF INVENTION

An object of the present disclosure is to provide a resistor allowing for adjusting the resistance value of its resistor body and also provide a method for manufacturing such a resistor.

A resistor according to an aspect of the present disclosure includes an insulating substrate, a resistor body, an electrode, and an oxynitride film. The resistor body contains Cr, Si, and N and is provided on the insulating substrate. The electrode contains at least one of Cu or Ag and is provided on the resistor body. The oxynitride film is provided on the resistor body. The electrode and the oxynitride film are arranged side by side in a second direction perpendicular to a first direction. The first direction defines a thickness direction with respect to the insulating substrate. The oxynitride film is a first oxynitride film, a second oxynitride film, or a third oxynitride film. The first oxynitride film is arranged to be in contact with an end portion of the electrode in the second direction. The second oxynitride film is arranged to leave a gap between the electrode and the second oxynitride film itself in the second direction. The third oxynitride film is arranged to overlap with a part of the electrode in the first direction.

A method for manufacturing a resistor according to another aspect of the present disclosure includes a substrate providing step, a resistor body forming step, an oxynitride film forming step, an oxynitride film removing step, and an electrode forming step. The substrate providing step includes providing an insulating substrate. The resistor body forming step includes forming a resistor body on the insulating substrate. The oxynitride film forming step includes forming an oxynitride film on the resistor body by conducting a heat treatment on the resistor body formed in the resistor body forming step. The oxynitride film removing step includes removing, by etching, at least a part of the oxynitride film formed in the oxynitride film forming step. The electrode forming step includes forming an electrode on a part, from which the oxynitride film has been removed in the oxynitride film removing step, of the resistor body.

### BRIEF DESCRIPTION OF DRAWINGS

FIG. 1 is a cross-sectional view of a resistor according to a first embodiment;

FIGS. 2A-2F are cross-sectional views illustrating respective steps of a manufacturing process of the resistor;

FIGS. 3A-3C are cross-sectional views illustrating an oxynitride film removing step belonging to the manufacturing process of the resistor;

FIG. 4 is a graph showing a relationship between an analytic depth in the resistor body and a corresponding quantitative value with respect to the resistor;

FIG. 5 is a cross-sectional view of a resistor according to a second embodiment;

FIG. 6 is a cross-sectional view of a resistor according to a third embodiment;

FIGS. 7A-7F are cross-sectional views illustrating respective steps of a manufacturing process of a resistor according to a fourth embodiment;

FIG. 8 is a cross-sectional view of a resistor according to a fifth embodiment; and

FIGS. 9A-9C are cross-sectional views illustrating an oxynitride film removing step belonging to a manufacturing process of a resistor according to a second variation of the first to fifth embodiments.

### DESCRIPTION OF EMBODIMENTS

Resistors and respective methods for manufacturing the resistors according to first to fifth embodiments will now be described with reference to the accompanying drawings. The drawings to be referred to in the following description of the first to fifth embodiments are all schematic representations. Thus, the ratio of the dimensions (including thicknesses) of respective constituent elements illustrated on the drawings does not always reflect their actual dimensional ratio. Note that the first to fifth embodiments to be described below are only exemplary ones of various embodiments of the present disclosure and should not be construed as limiting. Rather, the first to fifth embodiments may be readily modified in various manners depending on a design choice or any other factor without departing from the scope of the present disclosure.

### First Embodiment

### (1) Overview of Resistor

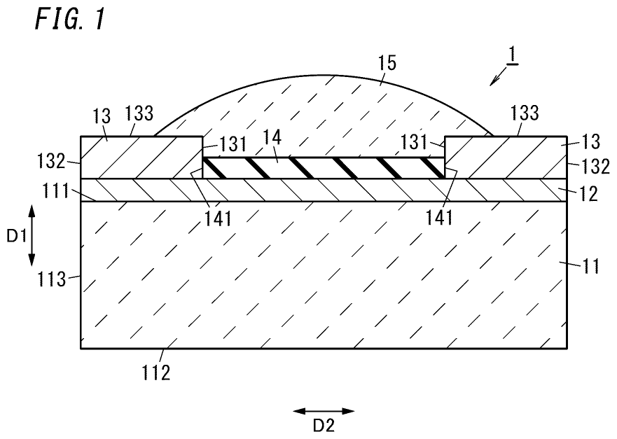

First of all, an overview of a resistor 1 according to a first embodiment will be described with reference to FIG. 1.

The resistor 1 according to the first embodiment is a chip resistor to be surface mounted (SMT). Specifically, the resistor 1 is designed to be mounted, using a surface mounter (mounter), for example, onto the surface (mounting surface) of a printed board. The resistor 1 may be, for example, a thin-film chip resistor.

The resistor 1 according to the first embodiment includes an insulating substrate 11, a resistor body 12, a pair of electrodes 13, and an oxynitride film 14 as shown in FIG. 1. The resistor body 12 contains chromium (Cr), silicon (Si), and nitrogen (N) and is provided on the insulating substrate 11. Each of the pair of electrodes 13 contains at least one of copper (Cu) or silver (Ag) and is provided on the resistor body 12. The oxynitride film 14 is provided on the resistor body 12. The pair of electrodes 13 and the oxynitride film 14 are arranged side by side in a second direction D2. The second direction D2 is perpendicular to a first direction D1 defining a thickness direction with respect to the insulating substrate 11. The oxynitride film 14 may be, for example, a first oxynitride film 14. The first oxynitride film 14 is arranged to be in contact with an end portion (end face 131) of the electrode 13 in the second direction D2.

In the resistor 1 according to the first embodiment, no oxynitride film 14 is formed over any of the electrodes 13, thus reducing the chances of causing instability in a resistance value of the resistor body 12 as measured with a probe brought into contact with the electrodes 13. Consequently, this makes it easier to adjust the resistance value of the resistor body 12.

### (2) Configuration for Resistor

Next, a configuration for a resistor 1 according to the first embodiment will be described with reference to FIG. 1.

As shown in FIG. 1, the resistor 1 according to the first embodiment includes an insulating substrate 11, a resistor body 12, a pair of electrodes 13, and an oxynitride film 14. The resistor 1 further includes a protective coating 15.

### (2.1) Insulating Substrate

The insulating substrate 11 may be, for example, a ceramic substrate. A material for the ceramic substrate may be, for example, an alumina sintered body, of which the alumina content is equal to or higher than 96%. The insulating substrate 11 is formed in a rectangular shape when viewed in plan in the first direction D1. As shown in FIG. 1, the insulating substrate 11 has a first principal surface (upper surface) 111, a second principal surface (lower surface) 112, and outer peripheral surfaces 113.

The first principal surface 111 and the second principal surface 112 face each other in the first direction D1. Each of the first principal surface 111 and the second principal surface 112 is a plane aligned with a second direction D2 perpendicular to the first direction D1. The outer peripheral surfaces 113 include four side surfaces, each of which is aligned with the first direction D1. The first direction D1 is a direction parallel to a thickness direction defined with respect to the insulating substrate 11 (i.e., the upward/downward direction in FIG. 1). The second direction D2 is a direction parallel to either the longitudinal axis or width axis (latitudinal axis) of the insulating substrate 11. That is to say, the second direction D2 is the rightward/leftward direction in FIG. 1. In the first embodiment, the second direction D2 is supposed to be a direction parallel to the longitudinal axis of the insulating substrate 11 as an example.

### (2.2) Resistor Body

The resistor body 12 may be, for example, a thin film, which is provided on the first principal surface 111 of the insulating substrate 11. That is to say, the resistor body 12 is provided on the insulating substrate 11. In the example shown in FIG. 1, the resistor body 12 is provided to cover the first principal surface 111 of the insulating substrate 11 entirely. The resistor body 12 may have, for example, a rectangular shape when viewed in plan in the first direction D1. However, this is only an example and should not be construed as limiting. Alternatively, the resistor body 12 may also have any other arbitrary shape according to the resistance value of its own.

The resistor body 12 may be made of, for example, an alloy including Cr, Si, and N. That is to say, the resistor body 12 contains Cr, Si, and N. An atom ratio of Si to Cr in the resistor body 12 is equal to or greater than 2/3 and equal to or less than 4 at least at the middle of the resistor body 12 in the first direction D1. In other words, the atom ratio of Cr to Si in the resistor body 12 is equal to or greater than three to two and equal to or less than one to four. Also, the total atomic percentage of N to the total atomic percentage of constituent metals of the resistor body 12 is equal to or less than 50 atom %. That is to say, an atomic percentage of N in the resistor body 12 is equal to or less than 50 atom % at least at the middle of the resistor body 12 in the first direction D1 (i.e., in the thickness direction defined with respect to the resistor body 12).

Also, in the resistor 1 according to the first embodiment, the resistor body 12 further contains oxygen (O). The atomic percentage of O in the resistor body 12 is equal to or less than 10 atom % at least at the middle of the resistor body 12 in the first direction D1.

The resistor body 12 is formed substantially in a rectangular shape by, for example, depositing a thin-film conductor over almost the entire surface of the insulating substrate 11 by a thin film deposition process such as sputtering and then removing excessive portions of the thin film conductor by photolithographic process.

The atomic composition ratio of the resistor body 12 is calculated based on the spectrum ratios that have been obtained on an element-by-element basis for Cr, Si, N, and O with respect to either the upper surface or a cross section of the resistor body 12 by, for example, transmission electron microscopy energy dispersive X-ray spectroscopy (TEM-EDX) or transmission electron microscopy electron energy loss spectroscopy (TEX-EELS). In addition, the atomic composition ratio of the resistor body 12 is also calculated by correcting, based on correction coefficients for the respective elements which have been evaluated by Rutherford backscattering spectrometry (RBS), the respective atomic composition ratios that have been evaluated by X-ray photoelectron spectroscopy (XPS).

In this case, the specific resistance of the resistor body 12 may be adjusted by changing the atom ratio of Si to Cr in the resistor body 12. The specific resistance of the resistor body 12 is preferably equal to or higher than 500 μΩ·cm and equal to or lower than 30,000 μΩ·cm.

### (2.3) Electrodes

The pair of electrodes 13 are provided on the resistor body 12. More specifically, the pair of electrodes 13 are provided to cover respective parts of the upper surface of the resistor body 12 at both longitudinal end portions of the resistor body 12 (i.e., both end portions of the resistor body 12 in the second direction D2). Each of the pair of electrodes 13 contains at least one of Cu or Ag. In the first embodiment, each of the pair of electrodes 13 contains Cu. Specifically, each of the pair of electrodes 13 is a made of a CuNi (copper-nickel) alloy. In each of the electrodes 13, the atomic percentage of Cu may be, for example, 60 atom %. In each of the electrodes 13, the atomic percentage of Ni may be, for example, 40 atom %. The pair of electrodes 13 are formed, by screen printing using a paste material, for example, on respective parts, from which the oxynitride film 14 has been removed, of the resistor body 12. Each of the pair of electrodes 13 may have, for example, a rectangular shape when viewed in plan in the first direction D1.

Each of the pair of electrodes 13 has a pair of end faces 131, 132 and a principal surface 133. The pair of end faces 131, 132 face each other in the second direction D2. Each of the pair of end faces 131, 132 is a plane aligned with the first direction D1. The principal surface 133 is a surface, facing away from the resistor body 12, of the electrode 13. The principal surface 133 is a plane aligned with the second direction D2. When the resistance value of the resistor body 12 is measured, a probe is brought into contact with the principal surface 133 of each of the pair of electrodes 13.

### (2.4) Oxynitride Film

The oxynitride film 14 is provided on the resistor body 12 as shown in FIG. 1. More specifically, the oxynitride film 14 is provided on a central part of the upper surface of the resistor body 12. That is to say, the oxynitride film 14 is not provided on either end portion of the upper surface of the resistor body 12 in the second direction D2. The pair of electrodes 13 are provided on the upper surface of the resistor body 12 to be located on both sides of the oxynitride film 14 in the second direction D2. That is to say, the pair of electrodes 13 and the oxynitride film 14 are arranged side by side in the second direction D2.

The oxynitride film 14 has a pair of end faces 141 as shown in FIG. 1. The pair of end faces 141 are both end faces of the oxynitride film 14 in the second direction D2. Each of the pair of end faces 141 is a plane aligned with the first direction D1. One end face 141 (on the left in FIG. 1) out of the pair of end faces 141 is in contact with the end face 131 of one electrode 13 (on the left in FIG. 1) out of the pair of electrodes 13. The other end face 141 (on the right in FIG. 1) out of the pair of end faces 141 is in contact with the end face 131 of the other electrode 13 (on the right in FIG. 1) out of the pair of electrodes 13. That is to say, the oxynitride film 14 is in contact with the respective end faces 131 of the pair of electrodes 13 in the second direction D2. In the resistor 1 according to the first embodiment, the oxynitride film 14 is a first oxynitride film (hereinafter referred to as a “first oxynitride film 14”). In the resistor 1 according to the first embodiment, the end face 131 of the electrode 13 is an end portion of the electrode 13.

### (2.5) Protective Coating

The protective coating (inorganic protective coating) 15 is a coating film provided to protect the resistor body 12. The protective coating 15 is formed to cover at least one of the resistor body 12 or the oxynitride film 14. In the example illustrated in FIG. 1, the protective coating 15 covers the oxynitride film 14 provided on the resistor body 12. In addition, in the example shown in FIG. 1, the protective coating 15 also partially covers the pair of electrodes 13 provided on both sides of the oxynitride film 14. That is to say, when viewed in plan in the first direction D1, the protective coating 15 covers the boundaries between the oxynitride film 14 and the pair of electrodes 13 and is provided continuously to cover not only the oxynitride film 14 but also respective parts of the pair of electrodes 13.

The protective coating 15 may be made of, for example, Al₂O₃ (alumina). The protective coating 15 is formed over the entire upper surface of the oxynitride film 14 and on respective parts of the principal surfaces 133 of the pair of electrodes 13 by applying alumina paste, for example.

### (3) Method for Manufacturing Resistor

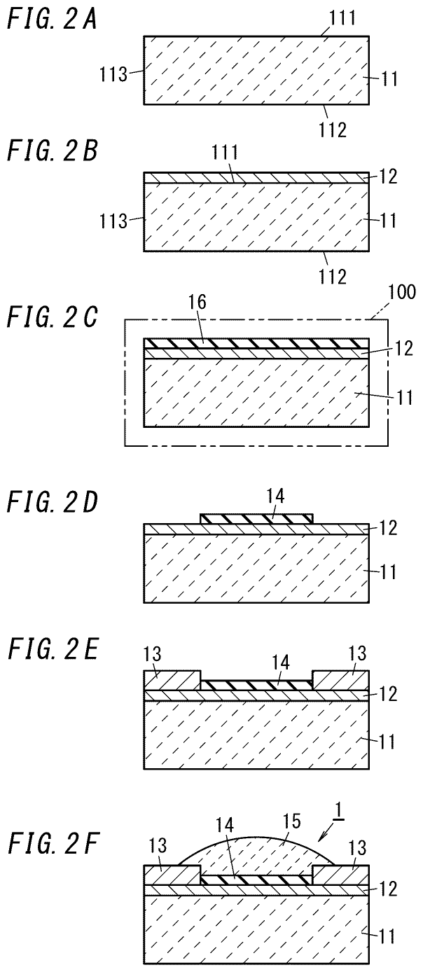

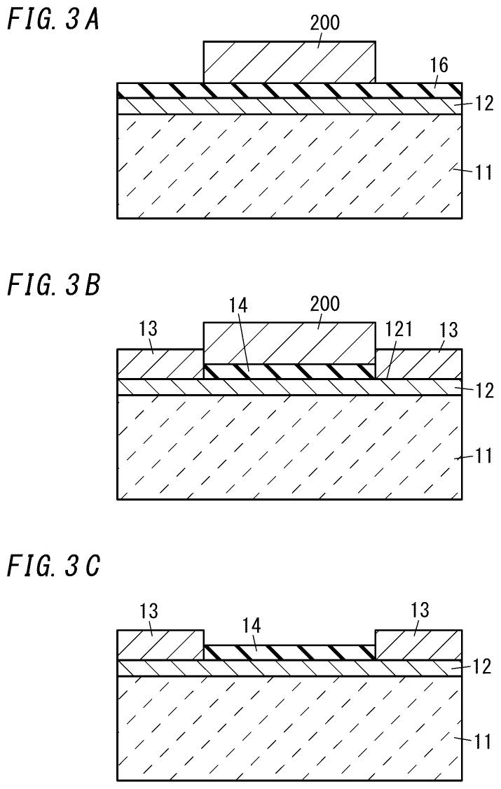

Next, a method for manufacturing a resistor 1 according to the first embodiment will now be described with reference to FIGS. 2A-3C.

A method for manufacturing a resistor 1 according to the first embodiment is a method for manufacturing the resistor 1 described above. The method for manufacturing the resistor 1 includes a substrate providing step, a resistor body forming step, an oxynitride film forming step, an oxynitride film removing step, and an electrode forming step. The method for manufacturing the resistor 1 further includes a protective coating forming step. In the method for manufacturing the resistor 1 according to the first embodiment, the substrate providing step, the resistor body forming step, the oxynitride film forming step, the oxynitride film removing step, the electrode forming step, and the protective coating forming step are performed in this order.

### (3.1) Manufacturing Process

First of all, a manufacturing process of the resistor 1 will be described with reference to FIGS. 2A-2F.

The substrate providing step is the step of providing the insulating substrate 11. More specifically, the substrate providing step includes arranging the insulating substrate 11 such that the first principal surface 111 thereof faces upward and the second principal surface 112 faces downward, for example, as shown in FIG. 2A.

The resistor body forming step is the step of forming the resistor body 12 on the insulating substrate 11. More specifically, the resistor body forming step includes forming the resistor body 12 over the first principal surface 111 of the insulating substrate 11 by either reactive sputtering in which nitrogen is caused to react or reactive sputtering in which nitrogen and oxygen are caused with react with each other. In the example illustrated in FIG. 2B, the resistor body 12 is formed over the entire first principal surface 111 of the insulating substrate 11. The sputtering target of the reactive sputtering may include, for example, Cr, Si, and O. In the sputtering target, an atom ratio of Si to Cr is three to seven and the atomic percentage of O is 20 atom %.

In addition, the resistor body forming step includes forming a pattern of the resistor body 12 on the insulating substrate 11. More specifically, the pattern of the resistor body 12 is formed by, for example, partially removing the resistor body 12 by photolithography.

The oxynitride film forming step is the step of forming an oxynitride film 16 on the resistor body 12 by conducting a heat treatment on the resistor body 12 that has been formed in the resistor body forming step. More specifically, the heat treatment is conducted by loading the insulating substrate 11 on which the resistor body 12 has been formed into a heat treatment furnace 100 as shown in FIG. 2C. As a result, the oxynitride film 16 is formed on the resistor body 12 as shown in FIG. 2C. The heat treatment temperature may be, for example, equal to or higher than 400° C. and equal to or lower than 800° C. In the first embodiment, the heat treatment temperature is 520° C., for example. In the first embodiment, the heat treatment temperature is a substantive temperature of the resistor body 12. However, the heat treatment temperature does not have to be the substantive temperature of the resistor body 12 but may also be, for example, the temperature of the atmosphere.

The oxynitride film removing step is the step of removing, by etching, at least a part of the oxynitride film 16 that has been formed in the oxynitride film forming step. More specifically, the oxynitride film removing step includes forming the oxynitride film 14 by removing both end portions of the oxynitride film 16, which has been formed on the resistor body 12, in the second direction D2 as shown in FIG. 2D. Note that the etching process will be described later in the “(3.2) Etching” section.

The electrode forming step is the step of forming the electrodes 13 on those parts, from which the oxynitride film 16 has been removed in the oxynitride film removing step, of the resistor body 12. More specifically, the electrode forming step includes forming the pair of electrodes 13 on both sides of the oxynitride film 14 in the second direction D2 by, for example, screen printing using a paste material as shown in FIG. 2E. In this embodiment, the thickness of each of the pair of electrodes 13 as measured in the first direction D1 is preferably greater than the thickness of the oxynitride film 14 as measured in the first direction D1 as shown in FIG. 2E.

As used herein, the expression “forming the electrodes 13 on those parts, from which the oxynitride film 16 has been removed in the oxynitride film removing step, of the resistor body 12” refers to both a situation where all of the electrodes 13 are formed as described above on those parts from which the oxynitride film 14 has been removed and a situation where only parts of the electrodes 13 (i.e., the parts except parts 134 (to be described later)) are formed on those parts from which the oxynitride film 14 has been removed. That is to say, the expression “forming the electrodes 13 on those parts, from which the oxynitride film 16 has been removed in the oxynitride film removing step, of the resistor body 12” means forming at least parts of the electrodes 13 on those parts, from which the oxynitride film 16 has been removed in the oxynitride film removing step, of the resistor body 12.

The protective coating forming step is the step of forming the protective coating 15 to cover at least one of the resistor body 12 or the oxynitride film 14. More specifically, the protective coating forming step includes forming the protective coating 15 over the entire upper surface of the oxynitride film 14 and respective parts of the principal surfaces 133 of the pair of electrodes 13 by applying, for example, alumina paste.

Suppose, as a comparative example, a situation where a heat treatment is conducted after electrodes have been formed on the resistor body. In that case, the heat treatment temperature is equal to or higher than 400° C. Thus, the electrodes need to be formed out of a material that has oxidation corrosion resistance at such a heat treatment temperature and that does not cause a decrease in adhesiveness to the resistor body. This narrows the range from which the electrode material may be selected, which is a problem with the comparative example.

In contrast, in the method for manufacturing the resistor 1 according to the first embodiment, the heat treatment is conducted with only the resistor body 12 formed on the insulating substrate 11, and the oxynitride film 16 formed on the resistor body 12 through the heat treatment is partially removed. After that, the electrodes 13 are formed on those parts from which the oxynitride film 16 has been removed. Consequently, there is no concern about the oxidation corrosion of the electrodes 13 or the decrease in the adhesiveness of the electrodes 13 to the resistor body 12 through the heat treatment, thus achieving the advantage of increasing the degree of freedom when the electrode material is selected.

### (3.2) Etching

Next, the etching to be performed in the oxynitride film removing step will be described with reference to FIGS. 3A-3C. In the first embodiment, the etching in the oxynitride film removing step is dry etching. The dry etching may be, for example, reverse sputtering, ion etching, or ion milling. The etch gas may be, for example, an argon (Ar) gas.

First, as shown in FIG. 3A, the oxynitride film 16 that has been formed on the resistor body 12 is selectively masked with a metallic mask 200 such that the metallic mask 200 covers a part of the oxynitride film 16 to be eventually left as the oxynitride film 14. Next, argon ions are caused to collide against the other parts, not masked with the metallic mask 200, of the oxynitride film 16. As a result, those parts, not masked with the metallic mask 200, of the oxynitride film 16 (i.e., parts located on both sides of the oxynitride film 14 in the second direction D2) are removed (refer to FIG. 3B).

Thereafter, with the oxynitride film 14 still masked with the metallic mask 200, a pair of electrodes 13 are formed on both sides of the oxynitride film 14 in the second direction D2. Finally, the metallic mask 200 is removed to obtain the structure shown in FIG. 3C.

Note that the etching process may include using a resist mask instead of the metallic mask 200. Optionally, the metallic mask 200 may be removed before the pair of electrodes 13 are formed.

### (4) Characteristics of Resistor

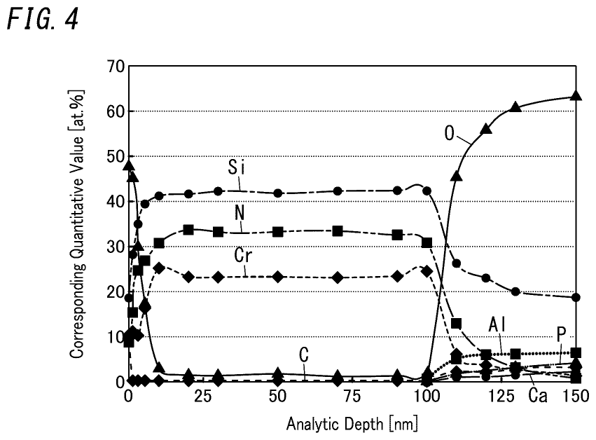

Next, the characteristics of the resistor 1 according to the first embodiment will be described with reference to FIG. 4. The results shown in FIG. 4 were obtained by conducting an element analysis of the resistor body 12 that had been formed (deposited) on a glass substrate. In FIG. 4, the abscissa indicates the analytic depth in the resistor body 12 and the ordinate indicates the corresponding quantitative value (atomic percentage) of each element. Also, in the example shown in FIG. 4, the atom ratio of Cr to Si in the resistor body 12 is one to two. In other words, the atom ratio of Si to Cr in the resistor body 12 is two. Furthermore, in the example shown in FIG. 4, the atomic percentage of N in the resistor body 12 is 30 atom %. Furthermore, in the example shown in FIG. 4, the thickness of the resistor body 12 (i.e., the thickness of the resistor body 12 as measured in the first direction D1) is 100 nm.

In the resistor 1 according to the first embodiment, the resistor body 12 contains Cr, Si, N, and O as described above. The thickness of the resistor body 12 is 100 nm as described above. Therefore, in this case, the middle of the resistor body 12 in the thickness direction (i.e., in the first direction D1) is 50 nm. Also, at a point where the analytic depth is 50 nm, the atomic percentage of O in the resistor body 12 is approximately 2 atom % (as indicated by the solid curve in FIG. 4). That is to say, in the resistor 1 according to the first embodiment, the atomic percentage of O in the resistor body 12 is equal to or less than 10 atom % at least at the middle (50 nm) of the resistor body 12 in the first direction D1.

In the resistor 1 according to the first embodiment, the resistor body 12 contains O, thus allowing the resistor body 12 to have higher specific resistance.

In the example shown in FIG. 4, the atomic percentage of O in the resistor body 12 is approximately 2 atom %. The atomic percentage of O in the resistor body 12 only needs to be equal to or less than 10 atom %. In addition, the atomic percentage of O in the resistor body 12 only needs to be equal to or greater than 0 atom %. That is to say, the atomic percentage of O in the resistor body 12 may be equal to or greater than 0 atom % and equal to or less than 10 atom %. The atomic percentage of O in the resistor body 12 is more preferably equal to or greater than 0.1 atom % and equal to or less than 10 atom %.

### (5) Advantages

In the resistor 1 according to the first embodiment, no oxynitride film 14 is formed over any of the electrodes 13, thus reducing the chances of causing instability in the resistance value of the resistor body 12 as measured with a probe brought into contact with the electrodes 13. Consequently, this makes it easier to adjust the resistance value of the resistor body 12. In addition, no oxynitride film 14 is formed, either, in any interface between the resistor body 12 and the electrodes 13, thus ensuring electrical connection between the resistor body 12 and the electrodes 13.

Furthermore, in the resistor 1 according to the first embodiment, the atom ratio of Si to Cr in the resistor body 12 is equal to or greater than 2/3 and equal to or less than 4 at least at the middle of the resistor body 12 in the first direction D1. Furthermore, the atomic percentage of N in the resistor body 12 is equal to or less than 50 atom % at least at the middle of the resistor body 12 in the first direction D1. This allows for increasing the specific resistance while decreasing the TCR at a time.

Besides, the resistor 1 according to the first embodiment allows the specific resistance of the resistor body 12 to be adjusted within the range equal to or higher than 500 μΩ·cm and equal to or lower than 30,000 μΩ·cm by changing the chemical compositions of Cr and Si in the resistor body 12.

Moreover, in the resistor 1 according to the first embodiment, the resistor body 12 further contains O. The atomic percentage of O in the resistor body 12 is equal to or less than 10 atom % at least at the middle of the resistor body 12 in the first direction D1. This allows the resistor body 12 to have higher specific resistance than in a situation where the resistor body 12 contains no O.

Furthermore, in the method for manufacturing the resistor 1 according to the first embodiment, an oxynitride film 14 is formed on the resistor body 12 by conducting a heat treatment on the resistor body 12 and then partially removed. Thereafter, electrodes 13 are formed on those parts, from which the oxynitride film 14 has been removed, of the resistor body 12. Consequently, there is no concern about the oxidation corrosion of the electrodes 13 or the decrease in adhesiveness of the electrodes 13 to the resistor body 12 through the heat treatment, thus increasing the degree of freedom when the electrode material is selected.

Furthermore, in the method for manufacturing the resistor 1 according to the first embodiment, the etching process performed in the oxynitride film removing step is dry etching. This makes it easier to remove at least a part of the oxynitride film 14.

Furthermore, the method for manufacturing the resistor 1 according to the first embodiment further includes a protective coating forming step. The protective coating formed in the protective coating forming step covers at least one of the resistor body 12 or the oxynitride film 14. This allows the resistor body 12 to be protected.

### Second Embodiment

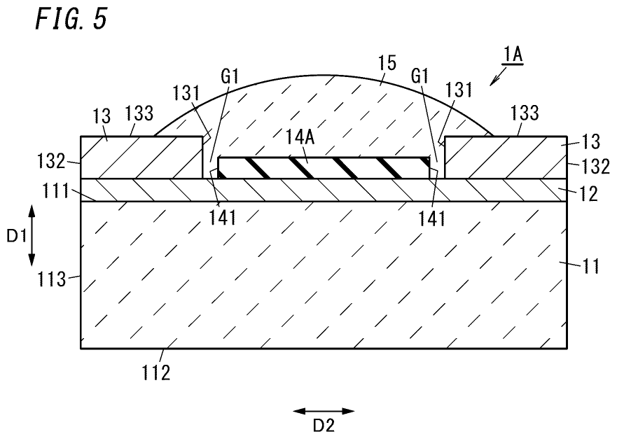

Next, a resistor 1A according to a second embodiment will be described with reference to FIG. 5. In the following description, any constituent element of the resistor 1A according to the second embodiment, having the same function as a counterpart of the resistor 1 (refer to FIGS. 1-3) according to the first embodiment described above, will be designated by the same reference numeral as that counterpart's, and description thereof will be omitted herein.

The resistor 1A according to the second embodiment includes a second oxynitride film 14A instead of the first oxynitride film 14, which is a difference from the resistor 1 according to the first embodiment described above.

As shown in FIG. 5, the resistor 1A according to the second embodiment includes an insulating substrate 11, a resistor body 12, a pair of electrodes 13, and the oxynitride film 14A. The resistor 1A according to the second embodiment further includes a protective coating 15.

The oxynitride film 14A is provided on the resistor body 12. The pair of electrodes 13 are provided on the resistor body 12. The pair of electrodes 13 and the oxynitride film 14A are arranged side by side in the second direction D2. In other words, the pair of electrodes 13 are provided on both sides of the oxynitride film 14A in the second direction D2. A gap G1 is left between each of the pair of electrodes 13 and the oxynitride film 14A. That is to say, the oxynitride film 14A is a second oxynitride film (hereinafter referred to as a “second oxynitride film 14A”) having a gap G1 between each of the pair of electrodes 13 and itself in the second direction D2. Therefore, each of the two end faces 141 of the second oxynitride film 14A is out of contact with the end face 131 of a corresponding one of the pair of electrodes 13.

Furthermore, in the resistor 1A according to the second embodiment, respective parts of the resistor body 12 (i.e., parts, corresponding to the gaps G1, of the resistor body 12) are exposed as shown in FIG. 5. Thus, in the resistor 1A according to the second embodiment, the protective coating 15 covers both the resistor body 12 and the oxynitride film 14A alike.

In the resistor 1A according to the second embodiment, no oxynitride film 14A is formed over any of the electrodes 13, either, thus reducing the chances of causing instability in the resistance value of the resistor body 12 as measured with a probe brought into contact with the electrodes 13. Consequently, this makes it easier to adjust the resistance value of the resistor body 12. In addition, no oxynitride film 14A is formed in the interface between the resistor body 12 and the electrodes 13, either, thus ensuring electrical connection between the resistor body 12 and the electrodes 13.

### Third Embodiment

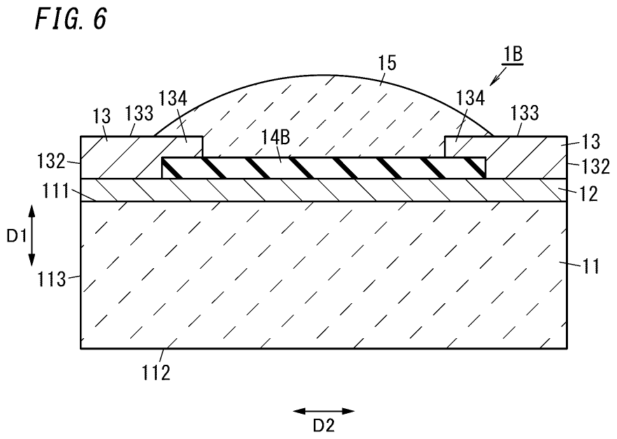

Next, a resistor 1B according to a third embodiment will be described with reference to FIG. 6. In the following description, any constituent element of the resistor 1B according to the third embodiment, having the same function as a counterpart of the resistor 1 (refer to FIGS. 1-3) according to the first embodiment described above, will be designated by the same reference numeral as that counterpart's, and description thereof will be omitted herein.

The resistor 1B according to the third embodiment includes a third oxynitride film 14B instead of the first oxynitride film 14, which is a difference from the resistor 1 according to the first embodiment described above.

As shown in FIG. 6, the resistor 1B according to the third embodiment includes an insulating substrate 11, a resistor body 12, a pair of electrodes 13, and the oxynitride film 14B. The resistor 1B according to the third embodiment further includes a protective coating 15.

The oxynitride film 14B is provided on the resistor body 12. In addition, the pair of electrodes 13 are provided on the resistor body 12. The pair of electrodes 13 and the oxynitride film 14B are arranged side by side in the second direction D2. In other words, the pair of electrodes 13 are provided on both sides of the oxynitride film 14B in the second direction D2. Each of the pair of electrodes 13 includes a part (extended portion) 134. The part 134 extends toward the oxynitride film 14B in the second direction D2. This causes the part 134 of each of the pair of electrodes 13 to overlap with the oxynitride film 14B in the first direction D1. That is to say, in the resistor 1B according to the third embodiment, the oxynitride film 14B is a third oxynitride film (hereinafter referred to as a “third oxynitride film 14B”)

In the resistor 1B according to the third embodiment, as well as in the resistor 1 according to the first embodiment, the protective coating 15 also covers the oxynitride film 14B provided on the resistor body 12. In addition, in the resistor 1B according to the third embodiment, the protective coating 15 further covers respective parts of the pair of electrodes 13 provided on both sides of the oxynitride film 14B.

In the resistor 1B according to the third embodiment, no oxynitride film 14B is formed over any of the electrodes 13, either, thus reducing the chances of causing instability in the resistance value of the resistor body 12 as measured with a probe brought into contact with the electrodes 13. Consequently, this makes it easier to adjust the resistance value of the resistor body 12. In addition, no oxynitride film 14B is formed in the interface between the resistor body 12 and the electrodes 13, either, thus ensuring electrical connection between the resistor body 12 and the electrodes 13.

### Fourth Embodiment

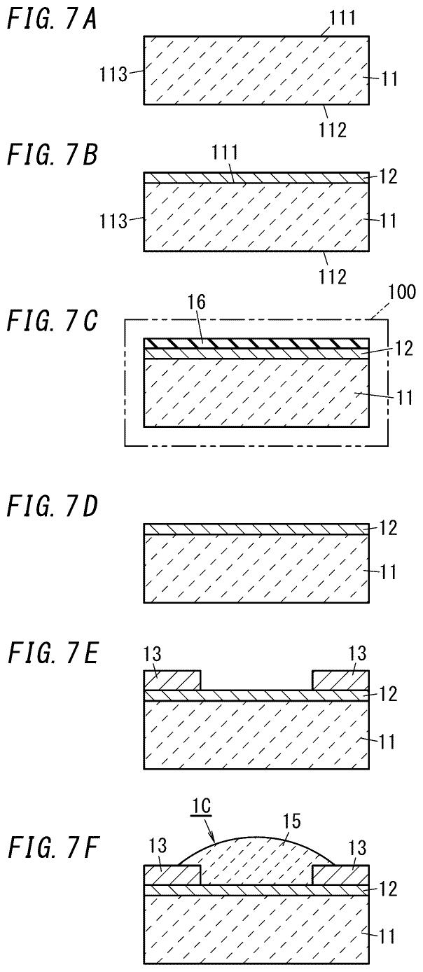

Next, a resistor 1C according to a fourth embodiment and a method for manufacturing the resistor 1C will be described with reference to FIGS. 7A-7F. In the following description, any constituent element of the resistor 1C according to the fourth embodiment, having the same function as a counterpart of the resistor 1 (refer to FIGS. 1-3) according to the first embodiment described above, will be designated by the same reference numeral as that counterpart's, and description thereof will be omitted herein.

The resistor 1C according to the fourth embodiment includes no oxynitride films, which is a difference from the resistor 1 according to the first embodiment.

The resistor 1C according to the fourth embodiment includes an insulating substrate 11, a resistor body 12, a pair of electrodes 13, and a protective coating 15 as shown in FIG. 7F. That is to say, in the resistor 1C according to the fourth embodiment, the oxynitride film 16 formed on the resistor body 12 in the oxynitride film forming step has been removed entirely (refer to FIG. 7D).

A method for manufacturing the resistor 1C according to the fourth embodiment includes a substrate providing step, a resistor body forming step, an oxynitride film forming step, an oxynitride film removing step, and an electrode forming step. The method for manufacturing the resistor 1C according to the fourth embodiment further includes a protective coating forming step. In the method for manufacturing the resistor 1C according to the fourth embodiment, the substrate providing step, the resistor body forming step, the oxynitride film forming step, the oxynitride film removing step, the electrode forming step, and the protective coating forming step are performed in this order.

The substrate providing step includes arranging an insulating substrate 11 such that the first principal surface 111 thereof faces upward and the second principal surface 112 thereof faces downward, for example, as shown in FIG. 7A.

The resistor body forming step includes forming a resistor body 12 over entire first principal surface 111 of the insulating substrate 11 as shown in FIG. 7B by a thin film deposition process such as sputtering.

The oxynitride film forming step includes forming an oxynitride film 16 on one surface (e.g., the upper surface in FIG. 7C) of the resistor body 12 by conducting a heat treatment with the insulating substrate 11, on which the resistor body 12 has been formed, loaded into a heat treatment furnace 100 as shown in FIG. 7C.

The oxynitride film removing step includes removing the oxynitride film 16 by dry etching, for example. In the example shown in FIG. 7D, the oxynitride film 16 is removed entirely in the oxynitride film removing step. That is to say, once the oxynitride film removing step has been performed, no oxynitride film is left.

The electrode forming step includes forming a pair of electrodes 13 on both end portions of the resistor body 12 in the second direction D2 by, for example, screen printing using a paste material as shown in FIG. 7E.

Finally, the protective coating forming step includes forming a protective coating 15 to cover the resistor body 12 and respective parts of the pair of electrodes 13 by applying, for example, alumina paste as shown in FIG. 7F.

In the resistor 1C according to the fourth embodiment, no oxynitride film is formed over any of the electrodes 13, either, thus reducing the chances of causing instability in the resistance value of the resistor body 12 as measured with a probe brought into contact with the electrodes 13. Consequently, this makes it easier to adjust the resistance value of the resistor body 12. In addition, no oxynitride film is formed in the interface between the resistor body 12 and the electrodes 13, either, thus ensuring electrical connection between the resistor body 12 and the electrodes 13.

Besides, in the method for manufacturing the resistor 1C according to the fourth embodiment, the oxynitride film 16 is formed on the resistor body 12 by conducting a heat treatment on the insulating substrate 11 on which only the resistor body 12 has been formed. Then, after the oxynitride film 16 on the resistor body 12 has been removed entirely, a pair of electrodes 13 are formed on the resistor body 12. Consequently, there is no concern about the oxidation corrosion of the electrodes 13 or a decrease in the adhesiveness of the electrodes 13 to the resistor body 12 through the heat treatment, thus increasing the degree of freedom when the electrode material is selected.

### Fifth Embodiment

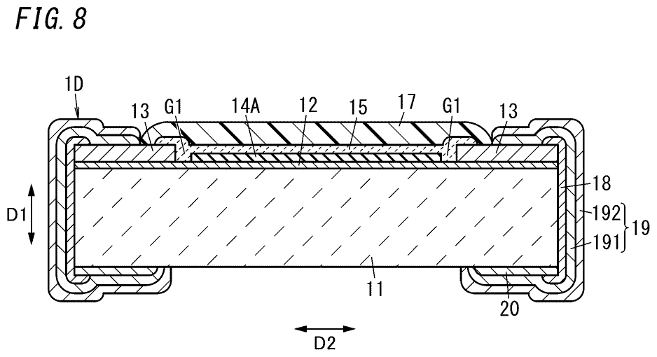

Next, a resistor 1D according to a fifth embodiment will be described with reference to FIG. 8. In the following description, any constituent element of the resistor 1D according to the fifth embodiment, having the same function as a counterpart of the resistor 1 (refer to FIGS. 1-3) according to the first embodiment described above, will be designated by the same reference numeral as that counterpart's, and description thereof will be omitted herein.

The resistor 1D according to the fifth embodiment further includes a second protective coating 17 different from the protective coating 15 (hereinafter referred to as a “first protective coating 15”), which is a difference from the resistor 1 according to the first embodiment. In addition, the resistor 1D according to the fifth embodiment further includes a pair of end face electrodes 18, a pair of plating layers 19, and a pair of back surface electrodes 20, which is another difference from the resistor 1 according to the first embodiment.

The resistor 1D according to the fifth embodiment includes an insulating substrate 11, a resistor body 12, a pair of electrodes 13 (hereinafter referred to as “a pair of upper surface electrodes 13”), an oxynitride film 14A, and the first protective coating 15. The resistor 1D further includes the second protective coating 17, the pair of end face electrodes 18, the pair of plating layers 19, and the pair of back surface electrodes 20.

The oxynitride film 14A may be, for example, a second oxynitride film (hereinafter referred to as a “second oxynitride film 14A”) arranged to leave a gap G1 between each of the pair of electrodes 13 and the oxynitride film 14A itself in the second direction D2.

The second protective coating (resin protective coating) 17 may be made of an epoxy resin, for example. The second protective coating 17 covers the first protective coating 15 entirely and the pair of upper surface electrodes 13 partially. That is to say, when viewed in plan in the first direction D1, the second protective coating 17 covers the boundaries between the first protective coating 15 and the pair of upper surface electrodes 13 to extend continuously from the first protective coating 15 through at least respective parts of the pair of upper surface electrodes 13.

The second protective coating 17 may be formed, for example, by applying an epoxy resin by screen printing and then causing the epoxy resin to cure by irradiating the epoxy resin with an ultraviolet ray. Note that respective parts, which are located between both longitudinal end portions of the first protective coating 15 in the second direction D2 (i.e., the parts covering the pair of upper surface electrodes 13) and the plating layers 19, of the pair of upper surface electrodes 13 are directly covered with the second protective coating 17.

Each of the pair of end face electrodes 18 may be made of, for example, a CuNi alloy. The pair of end face electrodes 18 are respectively located at both longitudinal ends of the insulating substrate 11 in the second direction D2. The pair of end face electrodes 18 are respectively formed at both longitudinal ends of the insulating substrate 11 by, for example, a thin film deposition process such as sputtering. The pair of end face electrodes 18 are electrically connected to the pair of upper surface electrodes 13, respectively.

Each of the pair of plating layers 19 includes an Ni plating layer 191 and an Sn plating layer 192 as shown in FIG. 8. Each of the pair of plating layers 19 is connected to a part of a corresponding one of the pair of upper surface electrodes 13 and is in contact with the second protective coating 17. In addition, each of the pair of plating layers 19 covers a corresponding one of the pair of end face electrodes 18.

Each of the pair of back surface electrodes 20 may be made of, for example, an epoxy resin containing silver (Ag) as a conductive substance. The pair of back surface electrodes 20 are respectively located at both longitudinal ends of the second principal surface 112 of the insulating substrate 11 in the second direction D2. The pair of back surface electrodes 20 may be formed, for example, by applying, by screen printing, an epoxy resin onto both longitudinal end portions of the second principal surface 112 of the insulating substrate 11 and then causing the epoxy resin to cure by irradiating the epoxy resin with an ultraviolet ray. The pair of back surface electrodes 20 correspond one to one to the pair of upper surface electrodes 13. Optionally, the pair of back surface electrodes 20 may be omitted.

In the resistor 1D according to the fifth embodiment, no oxynitride film 14 is formed over any of the upper surface electrodes 13, either, thus reducing the chances of causing instability in the resistance value of the resistor body 12 as measured with a probe brought into contact with the upper surface electrodes 13. Consequently, this makes it easier to adjust the resistance value of the resistor body 12. In addition, no oxynitride film 14 is formed in the interface between the resistor body 12 and the upper surface electrodes 13, either, thus ensuring electrical connection between the resistor body 12 and the upper surface electrodes 13.

Note that the oxynitride film 14A does not have to be the second oxynitride film but may also be the first oxynitride film in contact with the end portions of the electrodes 13 in the second direction D2 or the third oxynitride film partially overlapping with the electrodes 13 in the first direction D1.

### (Variations)

Note that the first to fifth embodiments described above are only exemplary ones of various embodiments of the present disclosure and should not be construed as limiting. Rather, the first to fifth embodiments may be readily modified in various manners depending on a design choice or any other factor without departing from the scope of the present disclosure. Next, variations of the first to fifth embodiments will be enumerated one after another. Note that the variations to be described below may be adopted in combination as appropriate.

### (1) First Variation

In the first to fifth embodiments described above, the resistor body 12 contains Cr, Si, N, and O. Optionally, the resistor body 12 may contain not only Cr, Si, N, and O but also aluminum (Al) as well. That is to say, in the resistor 1 according to the first variation, the resistor body 12 further contains Al. In the resistor body 12, the atomic percentage of Al is equal to or less than 30 atom % at least at the middle of the resistor body 12 in the first direction D1 (i.e., in the thickness direction defined with respect to the resistor body 12).

In the resistor 1 according to the first variation, the resistor body 12 contains not only Cr, Si, N, and O but also Al as well. This allows the specific resistance of the resistor body 12 to be increased, compared to a situation where the resistor body 12 contains no Al.

### (2) Second Variation

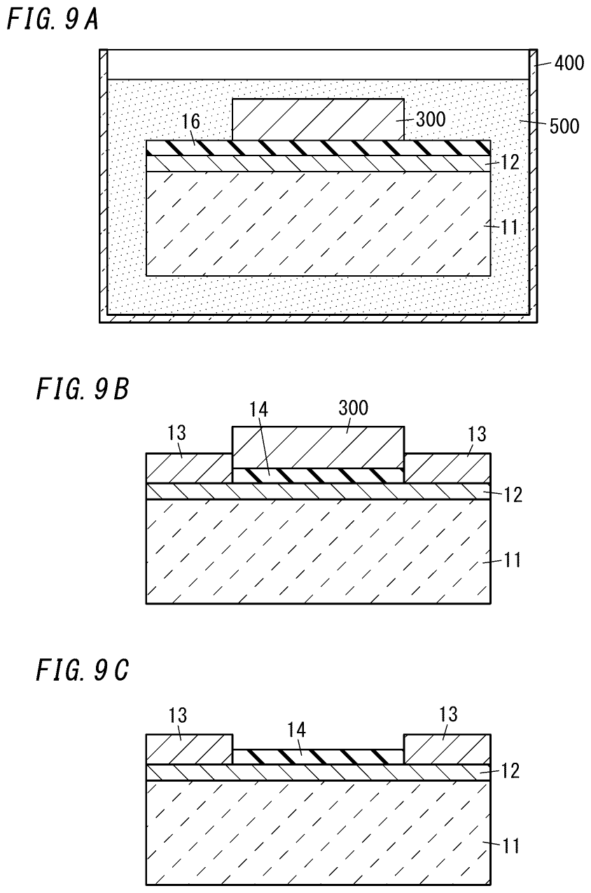

In the first to fifth embodiments described above, the etching process performed in the oxynitride film removing step is dry etching. However, this is only an example and should not be construed as limiting. The etching process does not have to be dry etching but may also be wet etching. As an example, it will be described with reference to FIGS. 9A-9C how to perform wet etching as the etching process.

When wet etching is performed, the insulating substrate 11 on which the oxynitride film 16 has been formed on the resistor body 12 is immersed in a solution 500 held in a vessel 400 as shown in FIG. 9A. The solution 500 is a solution that reacts with the oxynitride film 16 and may be, for example, hydrofluoric acid.

In the example shown in FIG. 9A, a central portion of the oxynitride film 16 is masked with a resist mask 300 to leave the central portion of the oxynitride film 16 as the oxynitride film 14. Thus, the rest of the oxynitride film 16 (i.e., its portion not masked with the resist mask 300) reacts with the solution 500 to be removed. As a result, the portion, masked with the resist mask 300, of the oxynitride film 16 will be the oxynitride film 14 as shown in FIG. 9B.

Next, as shown in FIG. 9B, a pair of electrodes 13 are formed on both sides of the oxynitride film 14 in the second direction D2. Then, the resist mask 300 is stripped to obtain the structure shown in FIG. 9C.

### (3) Other Variations

Next, other variations will be enumerated one after another.

In the first to fifth embodiments described above, the resistor body 12 contains O. However, the resistor body 12 does not have to contain O. That is to say, the resistor body 12 only needs to contain at least Cr, Si, and N.

In the first to fifth embodiments described above, each of the pair of electrodes 13 contains Cu. Alternatively, each of the pair of electrodes 13 may contain, for example, Ag or may also contain both Cu and Ag. That is to say, each of the pair of electrodes 13 needs to contain at least one of Cu or Ag.

If each of the pair of electrodes 13 contains Ag, then each of the pair of electrodes 13 may be made of, for example, an AgPd alloy. In each electrode 13, the atomic percentage of Ag may be, for example, 97 atom %. Also, in each electrode 13, the atomic percentage of Pd may be, for example, 3 atom %.

Also, if each of the pair of electrodes 13 contains both Cu and Ag, then each of the pair of electrodes 13 may be made of, for example, an AgCuPd alloy. In each electrode 13, the atomic percentage of Ag may be, for example, 98 atom %. Also, in each electrode 13, the atomic percentage of Cu may be, for example, 1 atom %. Furthermore, in each electrode 13, the atomic percentage of Pd may be, for example, 1 atom %.

In the first to fifth embodiments described above, the resistor body 12 is formed by a thin film deposition process such as sputtering. Alternatively, the resistor body 12 may also be formed by using a resistor body paste, for example.

In the first to fifth embodiments described above, the pair of electrodes 13 is formed by screen printing using a paste material. Alternatively, the pair of electrodes 13 may also be formed by a thin film deposition process such as sputtering.

### (Aspects)

The foregoing description provides specific implementations for the following aspects of the present disclosure.

A resistor (1; 1A; 1B; 1C; 1D) according to a first aspect includes an insulating substrate (11), a resistor body (12), an electrode (13), and an oxynitride film (14; 14A; 14B). The resistor body (12) contains Cr, Si, and N and is provided on the insulating substrate (11). The electrode (13) contains at least one of Cu or Ag and is provided on the resistor body (12). The oxynitride film (14; 14A; 14B) is provided on the resistor body (12). The electrode (13) and the oxynitride film (14; 14A; 14B) are arranged side by side in a second direction (D2) perpendicular to a first direction (D1). The first direction (D1) defines a thickness direction with respect to the insulating substrate (11). The oxynitride film (14; 14A; 14B) is a first oxynitride film (14), a second oxynitride film (14A), or a third oxynitride film (14B). The first oxynitride film (14) is arranged to be in contact with an end portion (131) of the electrode (13) in the second direction (D2). The second oxynitride film (14A) is arranged to leave a gap (G1) between the electrode (13) and the second oxynitride film (14A) itself in the second direction (D2). The third oxynitride film (14B) is arranged to overlap with a part (134) of the electrode (13) in the first direction (D1).

According to this aspect, no oxynitride film (14; 14A; 14B) is formed over the electrode (13), thus reducing the chances of causing instability in a resistance value of the resistor body (12) as measured with a probe brought into contact with the electrode (13). Consequently, this makes it easier to adjust the resistance value of the resistor body (12).

In a resistor (1; 1A; 1B; 1C; 1D) according to a second aspect, which may be implemented in conjunction with the first aspect, an atom ratio of Si to Cr in the resistor body (12) is equal to or greater than 2/3 and equal to or less than 4 at least at a middle of the resistor body (12) in the first direction (D1). An atomic percentage of N in the resistor body (12) is equal to or less than 50 atom % at least at the middle of the resistor body (12) in the first direction (D1).

This aspect allows for increasing the specific resistance and decreasing the TCR at a time.

In a resistor (1; 1A; 1B; 1C; 1D) according to a third aspect, which may be implemented in conjunction with the first or second aspect, the resistor body (12) has a specific resistance equal to or higher than 500 μΩ·cm and equal to or lower than 30,000 μΩ·cm.

This aspect allows the specific resistance of the resistor body (12) to be adjusted.

In a resistor (1; 1A; 1B; 1C; 1D) according to a fourth aspect, which may be implemented in conjunction with any one of the first to third aspects, the resistor body (12) further contains Al. An atomic percentage of Al in the resistor body (12) is equal to or less than 30 atom % at least at a middle of the resistor body (12) in the first direction (D1).

This aspect allows the resistor body (12) to have higher specific resistance than in a situation where the resistor body (12) contains no Al.

In a resistor (1; 1A; 1B; 1C; 1D) according to a fifth aspect, which may be implemented in conjunction with any one of the first to fourth aspects, the resistor body (12) further contains O. An atomic percentage of O in the resistor body (12) is equal to or less than 10 atom % at least at a middle of the resistor body (12) in the first direction (D1).

This aspect allows the resistor body (12) to have higher specific resistance than in a situation where the resistor body (12) contains no O.

A method for manufacturing a resistor (1; 1A; 1B; 1C; 1D) according to a sixth aspect includes a resistor body forming step, an oxynitride film forming step, an oxynitride film removing step, and an electrode forming step. The resistor body forming step includes forming a resistor body (12) on an insulating substrate (11). The oxynitride film forming step includes forming an oxynitride film (16) on the resistor body (12) by conducting a heat treatment on the resistor body (12) formed in the resistor body forming step. The oxynitride film removing step includes removing, by etching, at least a part of the oxynitride film (16) formed in the oxynitride film forming step. The electrode forming step includes forming an electrode (13) on a part, from which the oxynitride film (16) has been removed in the oxynitride film removing step, of the resistor body (12).

According to this aspect, no oxynitride film (14; 14A; 14B) is formed over the electrode (13), thus reducing the chances of causing instability in a resistance value of the resistor body (12) as measured with a probe brought into contact with the electrode (13). Consequently, this makes it easier to adjust the resistance value of the resistor body (12).

In a method for manufacturing a resistor (1; 1A; 1B; 1C; 1D) according to a seventh aspect, which may be implemented in conjunction with the sixth aspect, the etching is dry etching.

This aspect allows the oxynitride film (14; 14A; 14B) to be removed at least partially.

In a method for manufacturing a resistor (1; 1A; 1B; 1C; 1D) according to an eighth aspect, which may be implemented in conjunction with the sixth aspect, the etching is wet etching.

This aspect allows the oxynitride film (14; 14A; 14B) to be removed at least partially.

A method for manufacturing a resistor (1; 1A; 1B; 1C; 1D) according to a ninth aspect, which may be implemented in conjunction with any one of the sixth to eighth aspects, further includes a protective coating forming step. The protective coating forming step includes forming a protective coating (15) to cover the resistor body (12).

This aspect allows the resistor body (12) to be protected by the protective coating (15).

Note that the constituent elements according to the second to fifth aspects are not essential constituent elements for the resistor (1; 1A; 1B; 1C; 1D) but may be omitted as appropriate.

Note that the features according to the seventh to ninth aspects are not essential features for the method for manufacturing the resistor (1; 1A; 1B; 1C; 1D) but may be omitted as appropriate.

### REFERENCE SIGNS LIST

1, 1A, 1B, 1C, 1D Resistor
11 Insulating Substrate
12 Resistor Body
13 Electrode
14 First Oxynitride Film (Oxynitride Film)
14A Second Oxynitride Film (Oxynitride Film)
14B Third Oxynitride Film (Oxynitride Film)
15 Protective Coating
16 Oxynitride Film
131, 132 End Face (End Portion)
134 Part

D1 First Direction

D2 Second Direction

G1 Gap

1. A resistor comprising:
an insulating substrate;
a resistor body containing Cr, Si, and N and provided on the insulating substrate;
an electrode containing at least one of Cu or Ag and provided on the resistor body; and
an oxynitride film provided on the resistor body,
the electrode and the oxynitride film being arranged side by side in a second direction perpendicular to a first direction, the first direction defining a thickness direction with respect to the insulating substrate, and
the oxynitride film being:
a first oxynitride film arranged to be in contact with an end portion of the electrode in the second direction;
a second oxynitride film arranged to leave a gap between the electrode and the second oxynitride film itself in the second direction; or
a third oxynitride film arranged to overlap with a part of the electrode in the first direction.

2. The resistor of claim 1, wherein
an atom ratio of Si to Cr in the resistor body is equal to or greater than 2/3 and equal to or less than 4 at least at a middle of the resistor body in the first direction, and
an atomic percentage of N in the resistor body is equal to or less than 50 atom % at least at the middle of the resistor body in the first direction.

3. The resistor of claim 1, wherein
the resistor body has a specific resistance equal to or higher than 500 μΩ·cm and equal to or lower than 30,000 μΩ·cm.

4. The resistor of claim 1, wherein
the resistor body further contains Al, and
an atomic percentage of Al in the resistor body is equal to or less than 30 atom % at least at a middle of the resistor body in the first direction.

5. The resistor of claim 1, wherein
the resistor body further contains O, and
an atomic percentage of O in the resistor body is equal to or less than 10 atom % at least at a middle of the resistor body in the first direction.

6. A method for manufacturing a resistor, the method comprising:
a substrate providing step including providing an insulating substrate;
a resistor body forming step including forming a resistor body on the insulating substrate;
an oxynitride film forming step including forming an oxynitride film on the resistor body by conducting a heat treatment on the resistor body formed in the resistor body forming step;
an oxynitride film removing step including removing, by etching, at least a part of the oxynitride film formed in the oxynitride film forming step; and
an electrode forming step including forming an electrode on a part, from which the oxynitride film has been removed in the oxynitride film removing step, of the resistor body.

7. The method of claim 6, wherein
the etching is dry etching.

8. The method of claim 6, wherein
the etching is wet etching.

9. The method of claim 6, further comprising a protective coating forming step including forming a protective coating to cover at least one of the resistor body or the oxynitride film.
